(19) United States
(12) Patent Application Publication
(10) Pub. No.: US 2005/0165765 A1
(43) Pub. Date: Jul. 28, 2005

(54) Information search system, information search method, information search apparatus, and recording medium to which information search program, is recorded and which can be read by computer

(75) Inventors: Akira Neruse, Kawasaki (JP); Kouichi Kumon, Kawasaki (JP)

Correspondence Address: STAAS & HALSEY LLP, SUITE 700, 1201 NEW YORK AVENUE, N.W., WASHINGTON, DC, 20005, US

(73) Assignee: Fujitsu Limited, Kawasaki (JP)

(21) Appl. No.: 11/068,395

(22) Filed: Mar. 1, 2005

Related U.S. Application Data
(63) Continuation of application No. PCT/JP03/03245, filed on Mar. 18, 2003.

(51) Int. Cl. G06F 17/30

(52) U.S. Cl. 707/3

(57) ABSTRACT

The information search system includes a sub database creation unit for creating a plurality of sub databases each having a size equal to or less than the capacity of memory devices provided in the information processing apparatuses, an allocation management unit for allocating the sub databases to the information processing apparatuses as sub search requests and a coupling unit for acquiring results of processing as to the sub search requests issued by the information processing apparatuses and coupling them. Accordingly, when a search request to the database is processed by the plurality of information processing apparatuses in parallel, the information processing apparatuses can process the search request at high speeds, thereby the database can be searched at high speeds.

### FIELD OF THE INVENTION

The present invention relates to an information search system, an information search method, an information search apparatus, an information search program and a recording medium to which the program is recorded and which can be read by a computer, suitable for processing a search request to a database in parallel by a plurality of information processing apparatuses.

### DESCRIPTION OF THE RELATED ART

Recently, attention is paid to a method of deriving various kinds of information from data accumulated in a database, in addition to a method of simply accumulating data to the database. Although a capability for searching desired information at high speeds is required in the method, the database generally has such a tendency that an increase in an amount of accumulated data abruptly increases a processing amount of data to be searched to thereby increase a processing time.

To search the database at high speeds, it is known in recent years to search the database in parallel using a plurality of computers (workstations).

When a computer actually executes search processing to a database, it sequentially copies a database to be searched to a memory (main memory device) from an external memory device such as a hard disc and the like and executes the search processing to the data copied to the memory.

In general, since the external memory device such as the hard disc and the like, in which a database is stored, has a low input/output (I/O: Input/Output) speed, it takes a considerably long time to transfer data between the external memory device and the memory. Accordingly, when the search processing is executed, a search time is mainly determined by the data transfer time between the external memory device and the memory in many cases.

An ordinary OS (operating system) has a function called a disc cache, and data read out from the external memory device recently is stored in an unused portion of a memory by the disc cache function. Accordingly, when the database to be searched has been processed by other search processing beforehand, it may be not necessary to transfer data from the external memory device to the memory. Accordingly, when it is continuously required to search the same database, it is not necessary to transfer the data from the external memory device to the memory except a first search request. As a result, there is a possibility that a search time is greatly reduced.

However, the merit of reduction in the search time by a disc cache function can be obtained only when the size of a database is smaller than that of the memory. This is because if the size of the database is larger than that of the memory, the entire contents of the database cannot be stored in the memory.

FIG. 12 is a view schematically showing a relation between the size of a database and a search time in a conventional information search system. As shown in FIG. 12, when the size of the database to be searched is larger than that of the memory of a computer (calculation machine), even if search processing is executed to the same database beforehand, an access is executed to an external memory device such as a hard disc and the like. Thus, a bottle neck occurs in the transfer of data from the external memory device, thereby the search time is greatly increased as compared with a case that the size of the database is small.

Accordingly, the conventional information search system does not have an excellent method of greatly reducing the access to an external memory device when search processing is executed to a database whose size is larger than that of a memory included in a computer, from which a problem arises in that a search time is increased.

An object of the present invention, which was made in view of the above problem, is to provide an information search system, an information search method, an information search apparatus, an information search program, and a recording medium to which the program is recorded and which can be read by a computer, wherein when a search request to a database is processed in parallel by a plurality of the information processing apparatuses, the database can be searched at high speeds by processing the search request by the respective information processing apparatuses at high speeds.

### SUMMARY OF THE INVENTION

To achieve the above object, an information search system of the present invention including a plurality of information processing apparatuses to process a search request, which is composed of a database to be searched and a search condition to the database, in parallel by the plurality of information processing apparatuses, comprises a sub database creation unit for creating a plurality of sub databases each having a size equal to or less than the capacity of memory devices provided in the information processing apparatuses based on the search request, an allocation management unit for allocating the sub databases created by the sub database creation unit to the information processing apparatuses as sub search requests to cause the information processing apparatuses to process the search request to the sub databases, and a coupling unit for acquiring results of processing as to the sub search requests issued by the plurality of information processing apparatuses and coupling them.

Note that the information search system may comprise a sub search condition creation unit for creating sub search conditions by dividing the search condition, wherein the allocation management unit may allocate the sub search conditions to the information processing apparatuses as the sub search request to cause the information processing apparatuses to search the sub databases using the sub search conditions.

The information search system may comprise a DB affinity setting unit capable of setting information as to the sub databases, which are preferentially allocated to the information processing apparatuses by the allocation management unit as a DB affinity, wherein the allocation management unit may allocate the sub search requests to the information processing apparatuses based on the DB affinity.

The DB affinity setting unit may previously set sub databases which are preferentially processed, and the DB affinity setting unit may set the DB affinity based on the processing history of the sub search requests in the information processing apparatuses.

The information search system may comprise an empty capacity management unit for managing empty capacities of memory devices provided in the information processing apparatuses, wherein the allocation management unit may allocate the sub databases whose sizes are equal to or less than the empty capacities of the memory devices of the information processing apparatuses to the information processing apparatuses based on the empty capacities managed by the empty capacity management unit.

The information search system comprises a processing time prediction unit capable of predicting times required for processing as to the sub search requests executed by the information processing apparatuses, wherein the allocation management unit may preferentially allocate the sub search requests to the information processing apparatuses from a sub search request having a longer time required for the processing based on the times predicted by the processing time prediction unit.

The sub database creation unit or the sub search condition creation unit may divide each of the sub search requests which are not yet allocated to the information processing apparatuses by the allocation management unit and may create a plurality of sub search requests.

The information search system may comprise an evaluation unit for evaluating at least one of a DB affinity as to the information processing apparatuses set by the DB affinity setting unit, the sub databases, and times as to the processing predicted by the processing time prediction unit using an evaluation function, wherein the allocation management unit may allocate the sub search requests by a random drawing to the information processing apparatuses based on an evaluation result from the evalation unit.

An information search method of the present invention that process a search request, which is composed of a database to be searched and a search condition to the database, in parallel by a plurality of information processing apparatuses, comprises a sub search request creation step of creating a plurality of sub search requests each having a size equal to or less than the capacity of memory devices provided in the information processing apparatuses based on the search request, an allocation management step of allocating the sub search requests created at the sub search request creation step to the information processing apparatuses to cause the information processing apparatuses to process the sub search requests, and a coupling step of acquiring results of processing as to the sub search requests issued by the plurality of information processing apparatuses and coupling them.

An information search apparatus of the present invention for causing a plurality of information processing apparatuses to process a search request in parallel, which is composed of a database to be searched and a search condition to the database, comprises a sub search request creation unit for creating a plurality of sub search requests each having a size equal to or less than the capacity of memory devices provided in the information processing apparatuses based on the search request, an allocation management unit for allocating the sub search requests created by the sub search request creation unit to the information processing apparatuses to cause the information processing apparatuses to process the sub search requests, and a coupling unit for acquiring results of processing as to the sub search requests issued by the plurality of information processing apparatuses and coupling them.

In a recording medium of the present invention that can be read by a computer is a recording medium which records an information search program that causes a computer to execute an information search function for causing a plurality of information processing apparatuses to process a search request in parallel, which is composed of a database to be searched and a search condition to the database, the program causes the computer to function as a sub search request creation unit for creating a plurality of sub search requests each having a size equal to or less than the capacity of memory devices provided inh the information processing apparatuses based on the search request, an allocation management unit for allocating the sub search requests created by the sub search request creation unit to the information processing apparatuses to cause the information processing apparatuses to process the sub search requests, and a coupling unit for acquiring results of processing as to the sub search requests issued by the plurality of information processing apparatuses and coupling them.

As described above, according to the information search system, the information search method, the information search apparatus, and the recording medium, to which a information search program is recorded and which can be read by the computer, of the present invention, there can be obtained the following effects and the advantages.

(1) A plurality of sub databases having sizes equal to or less than the capacity of the memory devices provided in the information processing apparatuses are created and allocated to the information processing apparatuses as sub search requests to cause the information processing apparatuses to process a search request to the sub databases. With this operation, a sub database to be searched is cached in the memory device of an information processing apparatus which has processed a sub search request once. Accordingly, in order to access the sub database (disc access), the information processing apparatus need not access a hard disc whose access speed is low, thereby the sub data base can be searched at high speeds.

(2) Sub search requests each having an appropriate size (length of a predicted processing time) can be easily created by creating sub search conditions by dividing a search condition, from which high convenience can be obtained.

(3) Information as to a sub database, which is to be preferentially allocated to an information processing apparatus, is set as a DB affinity, and a sub search request (sub data base) is allocated to the information processing apparatus based on the DB affinity, thereby the sub search request can be easily allocated to the information processing apparatus.

(4) The DB affinity can be securely set by previously setting a sub data base which is to be preferentially processed as the DB affinity.

(5) The DB affinity can be easily set based on the processing history of the sub search requests in the information processing apparatuses.

(6) Empty capacities of the memory devices provided in the information processing apparatuses are managed and the sub data bases whose sizes are equal to or less than the empty capacities are allocated to the information processing apparatuses, thereby the sub data bases whose sizes are equal to or less than the empty capacities of the memory devices of the information processing apparatuses can be easily and securely allocated to the information processing apparatuses.

(7) Times required for processing as to the sub search requests by the information processing apparatuses are predicted and a sub search request having a longer time is preferentially allocated to the information processing apparatuses, thereby the plurality of sub search requests can be effectively allocated to the plurality of information processing apparatuses.

(8) An overall processing time (search time) in the system in its entirety can be reduced by creating a plurality of sub search requests by dividing each of the sub search requests which are not yet allocated to the information processing apparatuses to thereby shorten a processing speed. Further, a risk (a reading load of a sub data base) can be reduced by allocating a job to which the DB affinity is not fitted.

(9) Sub search requests are evaluated using an evaluation function as to at least one of a DB affinity, a sub data base, and a predicted time required for processing, and are allocated by a random drawing to the information processing apparatuses based on a result of the evaluation, thereby jobs can be easily and securely allocated to the information processing apparatuses.

### BRIEF DESCRIPTION OF THE DRAWINGS

FIG. 1 is a view showing a schematic arrangement of an information search system as an embodiment of the present invention.

FIGS. 2 to 4 are views explaining a method of creating sub search requests (jobs) in the information search system as the embodiment of the present invention, respectively.

FIG. 5 is a view explaining an example of an uneven job creation method in the information search system as the embodiment of the present invention.

FIG. 6 is a view explaining a dynamic job allocation method executed by an allocation management unit in the information search system as the embodiment of the present invention.

FIG. 7 is a view showing an example of jobs created by a sub search request creation unit in the information search system as the embodiment of the present invention.

FIG. 8 is a flowchart explaining the job allocation method executed by the allocation management unit in the information search system as the embodiment of the present invention.

FIG. 9 is a view showing an example of a state in which jobs are allocated to respective PCs by the allocation management unit in the information search system as the embodiment of the present invention.

FIG. 10 is a flowchart explaining other job allocation method executed by the allocation management unit in the information search system as the embodiment of the present invention.

FIG. 11 is a view showing an example of another state in which jobs are allocated to the respective PCs by the allocation management unit in the information search system as the embodiment of the present invention.

FIG. 12 is a view schematically showing a relation between the size of a database and a search time in a conventional information search system.

### DESCRIPTION OF THE PREFERRED EMBODIMENTS

An embodiment of the present invention will be explained below with reference to the drawings.

(A) Explanation of Embodiment

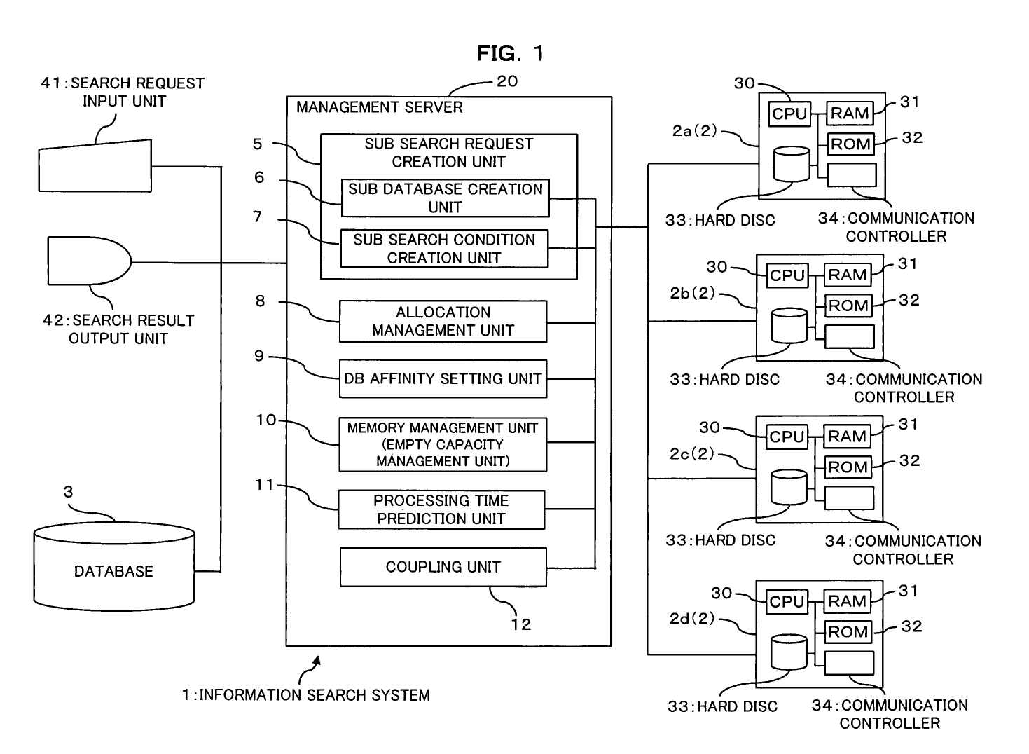

FIG. 1 is a view showing a schematic arrangement of an information search system as the embodiment of the present invention. The information search system 1 processes a search request to a database 3 input from a search request input unit 41 in parallel by a plurality (4 sets in the embodiment) of PCs (personal computers: information processing apparatuses) 2a, 2b, 2c, and 2d, and includes the search request input unit 41, a search result output unit 42, a management server 20, the database 3, and the PCs 2a, 2b, 2c, and 2d.

The database (object to be searched) 3 exhaustively collects some kind or another information (data) and accumulates them (group of information) and has a structure for executing addition, delete, update, and search of information, is searched based on the search request input from the search request input unit 41, and can provide information according to the search request.

The search request input unit 41 is used by an operator who inputs the search request, and the operator inputs a database to be searched (database 3 in the embodiment) and a search condition desired to the database through the search request input unit 41. The search request input unit 41 is realized by, for example, a keyboard, a mouse, and the like in a computer system.

Further, the search request is composed of the database to be searched and the search condition to the database. Although the embodiment is provided with only one database 3, it is by no means limited thereto. That is, the embodiment may be provided with a plurality of databases and at least one particular database of them may be used as a database to be searched, and further the operator may arbitrarily select at least one database as an object to be searched.

The operator can input any arbitrary search condition through the search request input unit 41.

The search result output unit 42 acquires a search result as to the search request, which is input from the search request input unit 41, from the management server 20 and outputs it to the operator and the like. The search result output unit 42 is realized by various kinds of output units, for example, a display unit, a printer, and the like.

The PCs 2a, 2b, 2c, and 2d are information processing apparatuses (calculation machines) for processing the search request input from the search request input unit 41, respectively. In the embodiment, the PCs 2a, 2b, 2c, and 2d process sub search requests, which are created by a sub search request creation unit 5 and allocated by an allocation management unit 8 in the management server 20, respectively and transmit results of the processing to the management server 20.

Note that, in the following description, when any particular one of the plurality of PCs must be specified, the reference numerals 2a, 2b, 2c, and 2d are used. However, when any arbitrary PC is specified, reference numeral 2 is used.

As shown in FIG. 1, each of the PCs 2a, 2b, 2c, and 2d includes a CPU (Central Processing Unit) 30, a RAM 31, a ROM 32, a hard disc 33, and a communication controller 34.

Note that in the figures, since the same reference numerals as those described above denote the same or approximately same portions, the detailed description of the portions is omitted.

The ROM 32 previously records a program called a BIOS (Basic Input/Output System) for executing basic input and output to and from the PC 2, and the hard disc 33 stores various programs such as an OS (operating system) and application programs, which cause the PC 2 to function, data, and the like.

The sub search request (described later) is processed by the CPU 30 which executes the various programs stored in the ROM 32 and the hard disc 33.

The RAM (memory unit) 31 temporarily stores and expands data when the CPU 30 executes various kinds of processing. In the embodiment, a sub database (the details of which will be described later) as the sub search request is expanded in the RAM 31.

In the information search system 1, it is assumed that the RAMs 31 provided in the PCs 2a, 2b, 2c, and 2d have the same capacity for the purpose of convenience.

The PC 2 has a disc cache function so that data having a high frequency of use and data used finally can be kept (cached) on the RAM 31. With this arrangement, when it is requested to read the data, the CPU 30 can read the data on the RAM 31 without the need of reading the data from the hard disc 33, the database 3, and the like which have a slow access speed, thereby the data can be processed at high speeds.

In the PC 2, a sub database processed once is kept on the RAM 31 by the disc cache function. Note that when new data is read by the RAM 31, the data cached on the RAM 31 is sequentially eliminated therefrom from older data by a first in first out system.

The communication controller 34 controls various kinds of data communication between the PC 2 and an external source and executes control of the reception of a sub search request (described later) transmitted from, for example, the management server 20 and the transmission of a result of search processed by the PC 2 to the management server 20.

The management server 20 causes a plurality of the PCs 2 to process the search request in parallel, which is input through the search request input unit 41, and further acquires results of processing executed by the PCs 2, couples the results of processing with each other, and outputs a result of search to the search result output unit 42.

As shown in FIG. 1, the management server 20 includes the sub search request creation unit 5, the allocation management unit 8, a DB affinity setting unit 9, a memory management unit (empty capacity management unit) 10, a processing time prediction unit 11, and a coupling unit 12.

The memory management unit (empty capacity management unit) 10 previously acquires and retains the size of the RAM 31 of the respective PCs 2 so that a sub database creation unit 6, which will be described later, can find the size of the RAM 31 of the respective PCs 2.

Further, the memory management unit 10 manages the states of use of the RAMs 31 of the respective PCs 2 and manages the sizes of the sub databases cached to the RAMs 31 of the respective PCs 2 by managing what kinds of sub search requests (sub database) are allocated to the PCs 2 by the allocation management unit 8 (the details of which will be described later). With the above operation, the states of use and the empty capacities (remaining capacities; the sizes of not used regions) of the RAMs 31 of the respective PCs 2 can be managed.

In the information search system 1, the PCs 2 execute only the processing (sub search requests) allocated by the management server 20 (allocation management unit 8), respectively so that the sub databases allocated by the allocation management unit 8 are cached to the RAMs 31 of the respective PCs 2.

The processing time prediction unit 11 predicts times required for the PCs 2 to execute processing as to the sub search requests, and the processing times can be predicted based on information of, for example, the sizes of the sub databases allocated to the PCs 2, the contents of a sub search condition, and the specification, the performance, and the like of the PCs 2 (CPUs 30). Note that the processing time prediction unit 11 may inquire times required for various types of processing to the PCs 2, and the prediction of the times can be embodied in various modifications within a scope which does not depart from the gist of the present invention.

The sub search request creation unit 5 creates sub search requests, which are to be processed by the PC 2, based on a search request input from the search request input unit 41. The sub search request creation unit 5 creates a plurality of the sub search requests (hereinafter, also referred to as jobs) using two methods, that is, a database dividing method and a query dividing method and includes a sub database creation unit 6 and a sub search condition creation unit 7 as shown in FIG. 1.

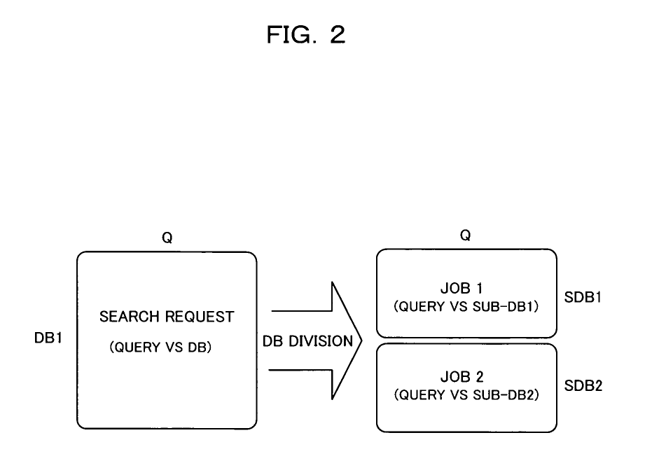

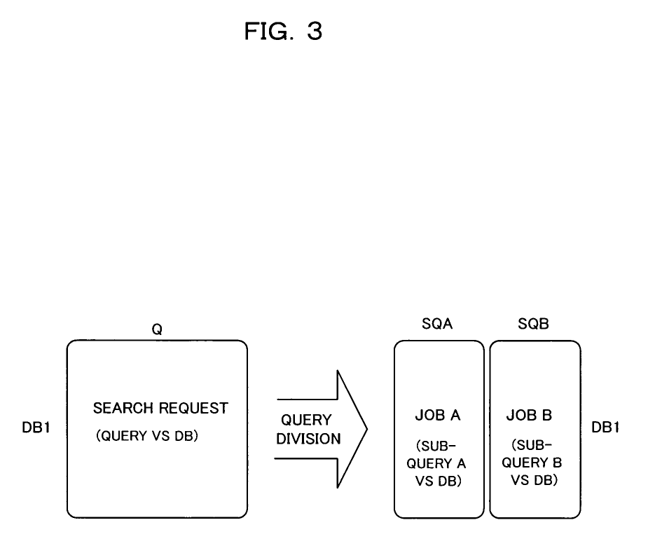

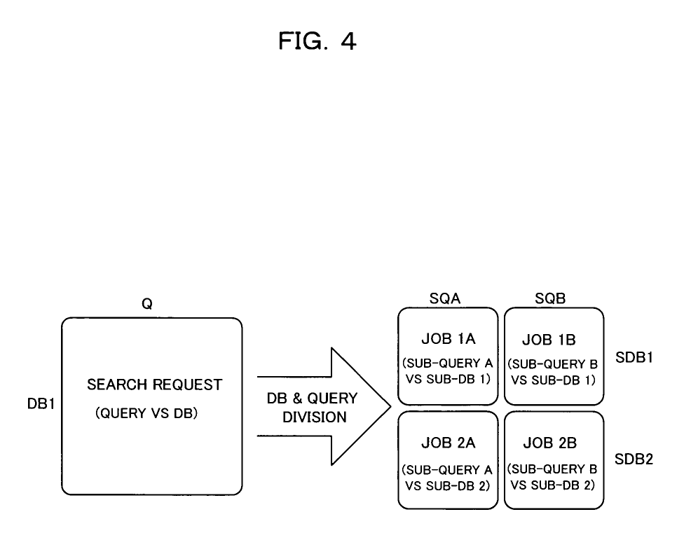

FIGS. 2 to 4 are views explaining a method of creating the sub search requests (jobs) in the information search system 1 as the embodiment of the present invention, respectively, wherein FIG. 2 is a view explaining a method of creating a plurality of the jobs by the database division, FIG. 3 is a view explaining the method of creating a plurality of the jobs by the query division, and FIG. 4 is a view explaining a method of creating a plurality of the jobs by the database division and the query division.

Note that FIGS. 2 to 4 show examples for creating a plurality of the jobs (sub search requests) by dividing a search request composed of a database DB1 (vertical axis in the figure) as an object to be searched and a query Q to the database [search condition; lateral axis in the figure].

The sub database creation unit 6 creates a plurality of sub databases whose sizes are equal to or less than the capacities of the RAMs 31 included in the respective PCs 2. In the example shown in FIG. 2, the sub database creation unit 6 divides the database DB1 into sub databases SDB1 and SDB2 by the database division as to the search request composed of the database DB1 and the query Q to thereby create two jobs, that is, a job 1 which searches the sub database SDB1 in response to the query Q and a job 2 which searches the sub database SDB2 in response to the query Q.

The sub database creation unit 6 creates a plurality of the sub databases whose sizes are equal to or less than the sizes of the RAMs 31 of the respective PCs 2 from the database 3 as to the search request input by the search request input unit 41 based on the information of the sizes of the RAMs 31 of the respective PCs 2 managed by the memory management unit 10.

When, for example, each of the PCs 2 has the RAM 31 of 256 MB, respectively, the sub database creation unit 6 creates a plurality of the sub databases of 256 MB or less.

In general, a database is often composed of a plurality of independent entries. Accordingly, the database can be easily divided using the entries as units. Further, since the database is characterized in that it has many entries, it has such a feature that even if there are many PCs 2, sub databases each having a uniform predicted search time can be easily created as many as the number of PCs 2.

The sub search condition creation unit 7 creates a plurality of jobs to be processed by the PCs 2 by dividing the search condition (query: search request) input from the search request input unit 41 into a plurality of sub search conditions having no dependent relation with each other. In the example shown in FIG. 3, the sub search condition creation unit 7 divides the search condition (query) Q of the search request composed of the database DB1 and the query Q into sub search conditions (sub queries) SQA and SQB by the query division to thereby create two jobs, that is, a job A for searching the database DB1 under the sub search condition SQA and a job B for searching the database DB1 under the sub search condition SQB.

Generally, in a search condition, since a plurality of search conditions are often dependent on each other, it is difficult to divide a search condition (query) as compared with the division of the database described above. However, if the search condition can be divided, sub search conditions resulting therefrom are often independent of each other. Accordingly, when the search condition can be divided once, a result of search obtained by processing the respective sub search conditions by a plurality of the PCs 2 is equal to that obtained by processing the search condition before it is divided by a single calculation machine (PC 2) in many cases. Accordingly, the query division has a feature in that a load of merge processing (to be described later), which is executed to a result of search as to the sub search conditions by the coupling unit 12, is relatively light.

Note that a query may be formed by an aggregation of perfectly independent search requests in a homology search which is often used in the field of bioinformatics such as BLAST (Basic Local Alignment Search Tool), FASTA, and the like. In this case, the coupling unit 12 has almost no load of merge resulting from the query division.

Further, in the embodiment, the query division can be executed by the sub search condition creation unit 7 in combination with the database division executed by the sub database creation unit 6. The database division has a feature in that it can be easily executed but the load of merge of a search result is heavy. Conversely, the query division has a feature in that it is difficult to execute it, but a the load of merge of a search result is light.

As described above, the database division and the query division have a contradictory feature in the easiness of database division and in the easiness of the merge of the result of search. However, when it is possible to apply both the database division and the query division, it is preferable to create a job by making use of the advantages of both the dividing methods. For example, first, jobs are created by the query division having the light merge load. Thereafter, when the necessary number and size of jobs cannot be created only by the query division, each of the jobs is further divided into a plurality of jobs by the database division (refer to FIG. 4), thereby the feature of both the dividing methods can be used. In the example shown in FIG. 4, the sub database creation unit 6 divides the database DB1 of the search request, which is composed of the database DB1 and the query Q, into the sub databases SDB1 and SDB2 by the database division. Further, the sub search condition creation unit 7 divides the search condition (query) Q of the search request, which is composed of the database DB1 and the query Q, into the sub search conditions (sub queries) SQA and SQB.

With the above operations, the sub search request creation unit 5 (sub database creation unit 6, the sub search condition creation unit 7) creates four jobs, that is, a job 1A, which searches the sub database SDB1 under the sub search condition SQA, a job 1B, which searches the sub database SDB1 under the sub search condition SQB, a job 2A, which searches the sub database SDB2 under the sub search condition SQA, and a job 2B, which searches the sub database SDB2 under the sub search condition SQB.

Further, the sub search request creation unit 5 creates jobs having a plurality of sizes and a different (uneven) predicted processing times (search times) in the PCs 2 by the sub database creation unit 6 and the sub search condition creation unit 7 (creation of uneven jobs). When there is a high correlation between, for example, a search time and the entry of a database, the uneven job creation method can be realized by creating a plurality of sub databases having a different number of entries by the sub database creation unit 6.

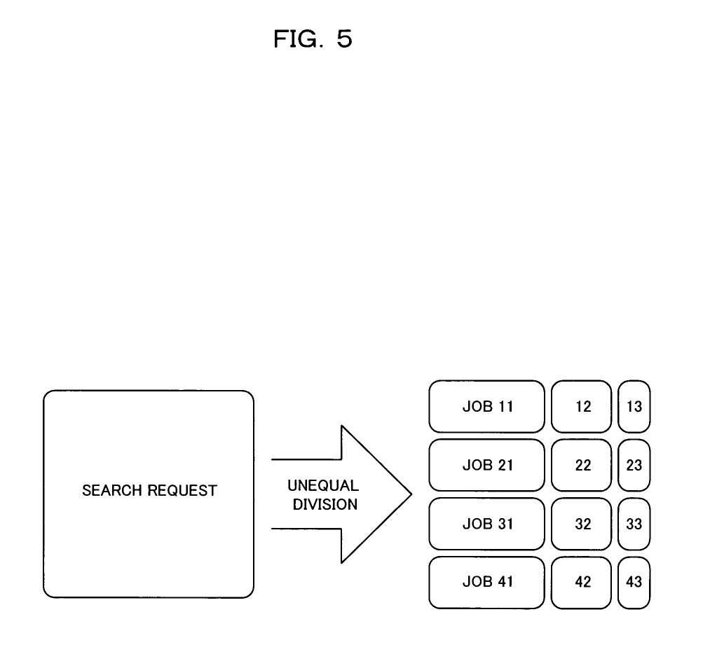

FIG. 5 is a view explaining an example of an uneven job creation method in the information search system 1 as the embodiment of the present invention. As shown in FIG. 5, to create the uneven jobs, first, jobs having approximately the same predicted search time, for example, are created as many as the number of PCs 2 (four jobs in the embodiment), and then each of the jobs is divided into three jobs so that the predicted search times thereof are set to the ratio of 4:2:1. With the above operation, 12 uneven jobs to the four PCs 2 can be easily created. Note that, for the sake of convenience, the thus created jobs are denoted by reference numerals 11, 12, 13, 21, 22, 23, 31, 32, 33, 41, 42, and 43 in the example shown in FIG. 5.

The DB affinity setting unit 9 can set information as to a sub database, which is preferentially allocated to a PC 2 by the allocation management unit 8, as a DB affinity (Database Affinity). That is, the DB affinity setting unit 9 can previously set a sub database, which is searched by each PC 2, to each PC 2. Note that although a plurality of sub databases may be set to respective PCs 2 as the DB affinity, the total sum of the sizes of the sub databases, which are set to one set of the PC 2 as the DB affinity, should not exceed the size (memory size) of the RAM 31 of the PC 2.

Note that an operator, a manager, and the like may previously set the sub databases, which are preferentially processed by the PCs 2, through the DB affinity setting unit 9, or the sub databases processed in the past may be preferentially set as the DB affinity based on the processing history of the sub databases in the PCs 2.

The allocation management unit 8 allocates the sub search requests created by the sub search request creation unit 5 (sub database creation unit 6, sub search condition creation unit 7) to the PCs 2. That is, the allocation management unit 8 allocates the sub databases and the sub search conditions created by the sub database creation unit 6 and the sub search condition creation unit 7 to the PCs 2 as the sub search requests (jobs) so that the PCs 2 process the search request to the sub databases.

Further, when a job is allocated to the PC 2, the allocation management unit 8 refers to the DB affinity set to the DB affinity setting unit 9 so that a sub database with which the DB affinity agrees is allocated to the PC 2.

That is, in the information search system 1, the database handled by each PC 2 is previously set as the DB affinity, and a job is allocated by the allocation management unit 8 according to the DB affinity. With this arrangement, a sub database to be searched is cached to the RAM 31 of the PC 2 which processed a sub search request once.

Then, the PC 2 positively processes the search request for the sub database according to the DB affinity. As a result, the PC 2 can search the sub database at high speeds without the need of a disc access to access the sub database.

Further, the allocation management unit 8 allocates the jobs to each of the PCs 2 using a dynamic job allocation method. The dynamic job allocation method is literally a method of allocating jobs to each of the PCs 2 dynamically. The dynamic job allocation method is realized by preparing jobs as many as or more than the number of PCs 2, allocating the jobs to each of the PCs 2 in the sequence of jobs having a longer predicted search time to cause the PCs 2 to process the jobs, selecting jobs having a longer predicted search time from the remaining jobs to sequentially allocate the jobs to the PCs 2 having finished the processing, and repeating the above processing until no job remains. Note that the dynamic job allocation method is particularly effective when the accuracy of the predicted search times of the jobs by the processing time prediction unit 11 in the PCs 2 is low.

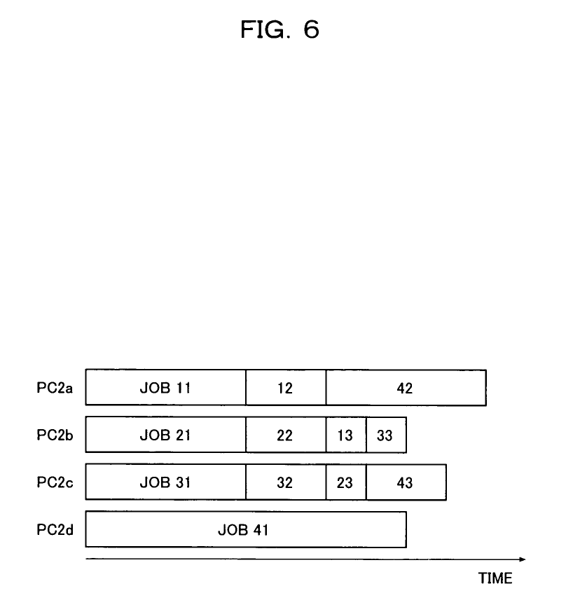

FIG. 6. is a view explaining the dynamic job allocation method executed by the allocation management unit 8 in the information search system 1 as the embodiment of the present invention, and shows an example of dynamically allocating a plurality of the jobs (refer to FIG. 5) created by the sub search request creation unit 5 to the four PCs 2a, 2b, 2c, and 2d. Note that, in the example shown in FIG. 6, it is assumed that times twice as long as the search times predicted by the processing time prediction unit 11 are taken in the jobs 41, 42, and 43.

In the example shown in FIG. 6, first, the jobs 11, 21, 31, 41 each having a long predicted search time are allocated to the PCs 2a, 2b, 2c, 2d, respectively. Thereafter, the jobs 12, 22, 32 each having a long predicted search time are allocated to the PCs 2a, 2b, 2c having finished the processing from the remaining jobs, respectively. After finishing the processing, the jobs 42, 13, 23 are allocated to the PCs 2a, 2b, 2c, respectively. Thereafter, the jobs 33, 43 are reallocated to the PCs 2b, 2c having finished the processing, respectively.

As described above, even if the accuracy of the search time predicted by the processing time prediction unit 11 in the processing is poor, a plurality of the jobs can be processed at high speeds by dynamically allocating the jobs to the PCs 2.

Note that the dynamic allocation of jobs as described above is complex in a job management and applies a large load to the job management as compared with a static job allocation. Accordingly, when the search time is predicted with a high accuracy by the processing time prediction unit 11, it is not always necessary to execute the dynamic job allocation, and the static job allocation may be executed.

A static job allocation method is literally a method of allocating jobs to the PCs 2 statically. In the static job allocation method, when there is a high correlation between, for example, a search time and the number of entries of a database, the database is divided to create jobs as many as the number of PCs 2 so that the jobs have the same number of entries, and the jobs are only statically allocated to the PCs 2, thereby a load can be balanced between the PCs 2.

Note that it can be said that when a search time prediction accuracy is poor, the dynamic job allocation method can more reduce an overall processing time than the static job allocation method. When, for example, jobs as many as the number of PCs 2 are created and processed by the PCs 2, respectively, if processing of a job takes a time twice that of the other jobs, the performance of the overall system 1 is determined by the search time of the job taking the twice time. Accordingly, in this case, an effect of executing processing by a plurality of the PCs 2 operating in parallel is indefinite.

That is, when jobs can be managed easily and the processing times (predicted search times) of the respective jobs can be predicted with a high accuracy, the static job allocation method is more effective than the dynamic job allocation method.

Further, when jobs to be allocated to the PCs 2 are determined, the allocation management unit 8 may calculate the evaluation values of the jobs which are not yet allocated using an evaluation function and determine the jobs to be allocated to the PCs 2. Evaluation functions shown below are contemplated as simple examples of them.

(1) When a sub database to be searched of a job agrees with a DB affinity of a PC 2:

evaluation value=predicted search time of job

(2) When a sub database to be searched of a job do not agree with a DB affinity of a PC 2:

evaluation value=predicted search time of job/2

When the evaluation functions shown above are used, the allocation management unit 8 selects a job having a highest evaluation value from the jobs which are not yet allocated and allocates the selected job to a PC 2.

The coupling unit 12 acquires results of processing as to the jobs (sub search requests) executed by the PCs 2, couples (merges) the results with each other. That is, the coupling unit 12 creates a result of search to the search request input from the search request input unit 41. The result of search coupled by the coupling unit 12 is transmitted to the search result output unit 42.

In the information search system 1 as the embodiment of the present invention arranged as described above, when a search request (database to be searched and search condition) is input by a user through the search request input unit 41, the search request is transmitted to the management server 20.

In the management server 20, the sub search request creation unit 5 creates a plurality of jobs (sub search requests) to be processed by the plurality of PCs 2 based on the search request input from the search request input unit 41 (sub search request creation step). Specifically, the sub database creation unit 6 creates a plurality of sub databases each of which is equal to or less than the capacity of the RAM 31 of each PC 2. Further, the sub search condition creation unit 7 creates sub search requests, when necessary, based on the search condition input from the search request input unit 41 as the search request.

Further, the sub search request creation unit 5 creates an uneven job based on the processing time predicted by the processing time prediction unit 11.

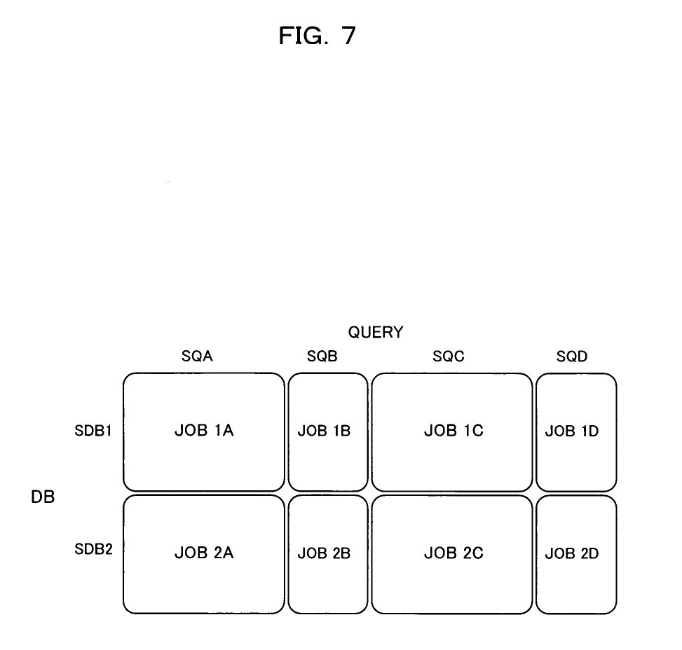

FIG. 7 is a view showing an example of a job created by the sub search request creation unit 5 in the information search system 1 as the embodiment of the present invention, and shows an example in which a plurality of jobs are created based on a search request for searching the database 3 having a size 1.5 times (for example, 384 MB) that (for example, 256 MB) of each of the RAMs 31 of the four PCs 2 (2a, 2b, 2c, 2d).

In the example shown in FIG. 7, two sub databases SDB1 and SDB2 are created by the sub database creation unit 6 based on the database 3 so that the sub databases SDB1 and SDB2 have a memory size smaller than that of each of the RAMs 31 of the PCs 2.

Further, in the example shown in FIG. 7, the sub search condition creation unit 7 creates four sub search conditions SQA, SQB, SQC, SQD by dividing the search request input from the search request input unit 41.

That is, in the example shown in FIG. 7, eight jobs (sub search requests) 1A, 1B, 1C, 1D, 2A, 2B, 2C, 2D are created by the sub database creation unit 6 and the sub search condition creation unit 7.

Note that it is assumed that the jobs 1B, 1D, 2B, 2D require approximately the same search times with each other which are predicted by the processing time prediction unit 11 as well as the jobs 1A, 1C, 2A, 2C require approximately the same search times with each other, and further the jobs 1A, 1C, 2A, 2C require a predicted search time approximately twice that of the jobs 1B, 1D, 2B, 2D.

Further, in the example shown in FIG. 7, it is assumed that the DB affinity setting unit 9 sets the DB affinity such that the sub database SDB1 is preferentially allocated to the PC 2a and the PC 2b and the sub database SDB2 is preferentially allocated to the PC 2c and the PC 2d.

Then, the allocation management unit 8 allocates the respective jobs 1A, 1B, 1C, 1D, 2A, 2B, 2C, 2D created by the sub search request creation unit 5 as described above to the PCs 2 according to the DB affinity set by the DB affinity setting unit 9 (allocation management step). Further, at this time, the allocation management unit 8 allocates the respective jobs to the PC 2 using the dynamic job allocation method.

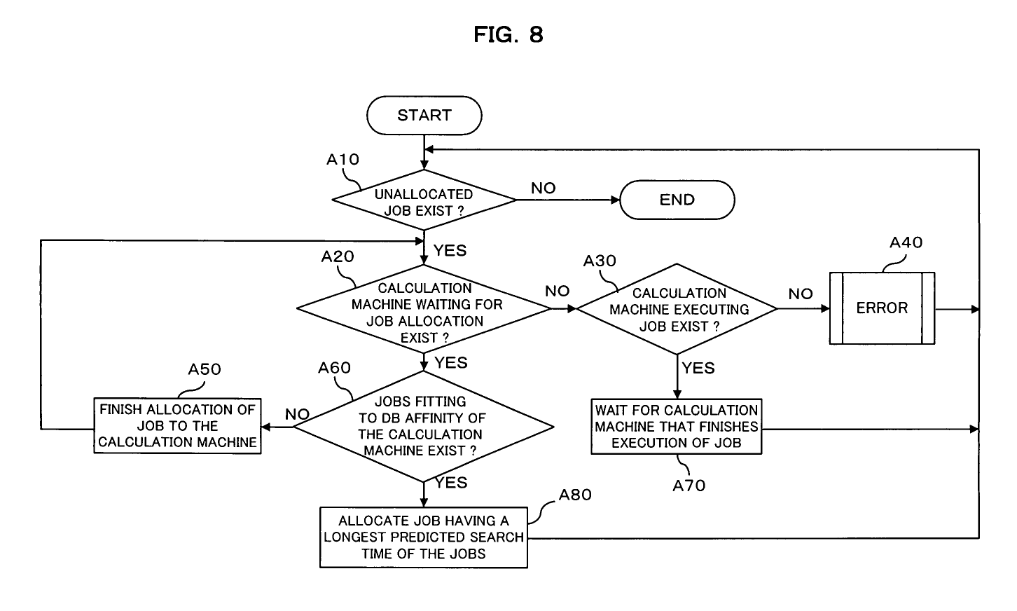

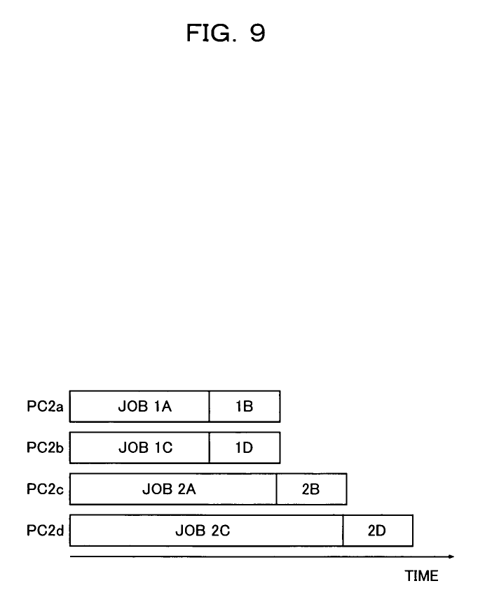

Here, a job allocation method executed by the allocation management unit 8 in the information search system 1 as the embodiment of the present invention will be explained according to a flowchart (steps A10-A80) shown in FIG. 8 with reference to FIG. 9. Note that FIG. 9 is a view showing an example of a state in which jobs are allocated to the PCs 2 by the allocation management unit 8 in the information search system 1 as the embodiment of the present invention.

The allocation management unit 8 determines whether or not there is an unallocated job (step A10), and when there is no unallocated job (refer to NO route of step A10), the processing is finished.

Further, when there is an unallocated job (refer to YES route of step A10), the allocation management unit 8 determines whether or not there is a PC 2 waiting for allocation of a job, that is, whether or not there is a PC 2 capable of processing a job (step A20).

When there is a PC 2 waiting for the allocation of a job (refer to YES route of step A20), the allocation management unit 8 determines whether or not there is a job whose DB affinity is fitted to (agrees with) the PC 2 (step A60). When there is a job whose DB affinity is fitted to the PC 2 (refer to YES route of step A60), the job having the longest predicted search time of the jobs having the DB affinity fitted to the PC 2 is allocated to the PC 2 (step A80) with reference to the search times predicted by the processing time prediction unit 11, and the process goes to step A10.

Further, when there is no job whose DB affinity is fitted to the PC 2 (refer to NO route of step A60), allocation of a job to the PC 2 is finished (step A50), and the process returns to step A20.

In contrast, when there is no PC 2 waiting for allocation of a job (refer to NO route of step A20), the allocation management unit 8 determines whether or not there is a PC 2 executing a job (step A30). When there is a PC 2 executing a job (refer to YES route of step A30), the allocation management unit 8 waits for the job of the PC 2 to be finished (step A70), and the process returns to step A10. Further, when there is no PC 2 executing a job (refer to NO route of step A30), the allocation management unit 8 outputs a message indicating an error to an operator and the like in the information search system (step A40), and the process returns to step A10.

As shown in FIG. 9, jobs are dynamically allocated to the PCs 2 by the job allocation method described above. Note that it is assumed in the example shown in FIG. 9 that the processing time of the job 2C is 1.5 times the search time predicted by the processing time prediction unit 11 and that processing time of the job 2D is twice the search time predicted by the processing time prediction unit 11.

As described above, when the allocation management unit 8 allocates the jobs to the PCs 2, the PCs 2 process the jobs allocated thereto. That is, the PCs 2 search sub databases based on the sub search conditions and transmit results of search to the management server 20.

Note that since the size of the sub database allocated to each of the PCs 2 is smaller than the size of the RAM 31 provided in each of the PCs 2, when the sub database is searched based on the sub search condition, it can be searched by being expanded on the RAM 31, thereby the sub database can be searched at high speeds without the need of accessing a disc and the like.

Results of search executed by the PCs 2 are coupled with each other (merged) by the coupling unit 12 in the management server 20, transmitted to the search result output unit 42 as a result of search to a search request, and presented to the operator.

As described above, according to the information search system 1 as the embodiment of the present invention, the sub database creation unit 6 (sub search request creation unit 5) creates a plurality of sub databases each having a size equal to or less than the capacity of each of the RAM 31 provided in the PCs 2, and the allocation management unit 8 allocates the sub databases to the PCs 2. Accordingly, a sub database to be searched is cached in the RAM 31 of the PC 2 which has processed a sub search request once. With the above arrangement, in order to access the sub database (disc access), the PC 2 need not access a hard disc whose access speed is low, thereby the sub database can be searched at high speeds.

In particular, since a sub database to be processed by each PC 2 is previously set to the DB affinity setting unit 9 as the DB affinity and the allocation management unit 8 allocates a job according to the DB affinity, thereby the allocation management unit 8 can easily allocate the jobs (sub databases) to the PCs 2. Further, since a sub database to be searched is cached in the RAM 11 in the PC 2 which has processed a sub search request once, the PC 2 does not need the disc access to access the sub database, thereby the sub database can be searched at high speeds.

Since the sub search condition creation unit 7 creates sub search conditions by dividing the search condition input from the search request input unit 41, sub search requests having an appropriate (arbitrary) size (length of a predicted search time) can be easily created, from which high convenience can be obtained.

Since the processing time prediction unit 11 predicts the predicted search times of the respective jobs, the allocation management unit 8 can easily allocate the jobs dynamically, from which high convenience can be obtained.

The DB affinity setting unit 9 can securely set the DB affinity by previously setting the sub databases, which are preferentially processed by the PCs 2, by the operator, the manager and the like and further the DB affinity can be easily set by preferentially setting the sub databases processed in the past as the DB affinity based on the processing history of the sub data bases processed by the PCs 2.

The memory management unit 10 manages empty capacities of the RAMs 31 provided in the PCs 2 and allocates sub databases whose sizes are equal to or less than the empty capacities to the PCs 2. As a result, the sub databases whose sizes are equal to or less than the empty capacities of the RAMs 31 of the PCs 2 can be easily and securely allocated to the PCs 2.

The processing time prediction unit 11 predicts times required for the PCs 2 to process as to the respective sub search requests (predicted search times), and the allocation management unit 8 preferentially allocates the sub search requests having a longer predicted search time to the PCs 2, thereby a plurality of the jobs can be effectively allocated to the plurality of PCs 2.

(B) Others

The present invention is by no means limited to the embodiment described above and can be embodied in various modifications within a scope which does not depart from the gist of the present invention.

For example, even if the DB affinity of a sub database is not fitted to a PC2, the allocation management unit 8 may allocate a job whose data size is equal to or less than the remaining amount of the RAM 31 of the PC 2 to the PC 2. In addition, the sub search request creation unit 5 may further divide an (unallocated) job (sub database) which is not yet allocated to a PC 2 so that the data size thereof is set equal to or less than the remaining capacity of the RAM 31 of the PC 2 and allocate a divided job to the PC 2.

That is, in the information search system 1, the allocation management unit 8 may acquire the states of use or the empty capacities (sizes of not used regions) of the RAMs 31 of the respective PCs 2 from the empty capacity management unit 10, the sub search request creation unit 5 may further divide the unallocated job to a plurality of jobs (sub databases) each having a size equal to or less than empty capacities, and the jobs created by the division may be allocated to the PCs 2.

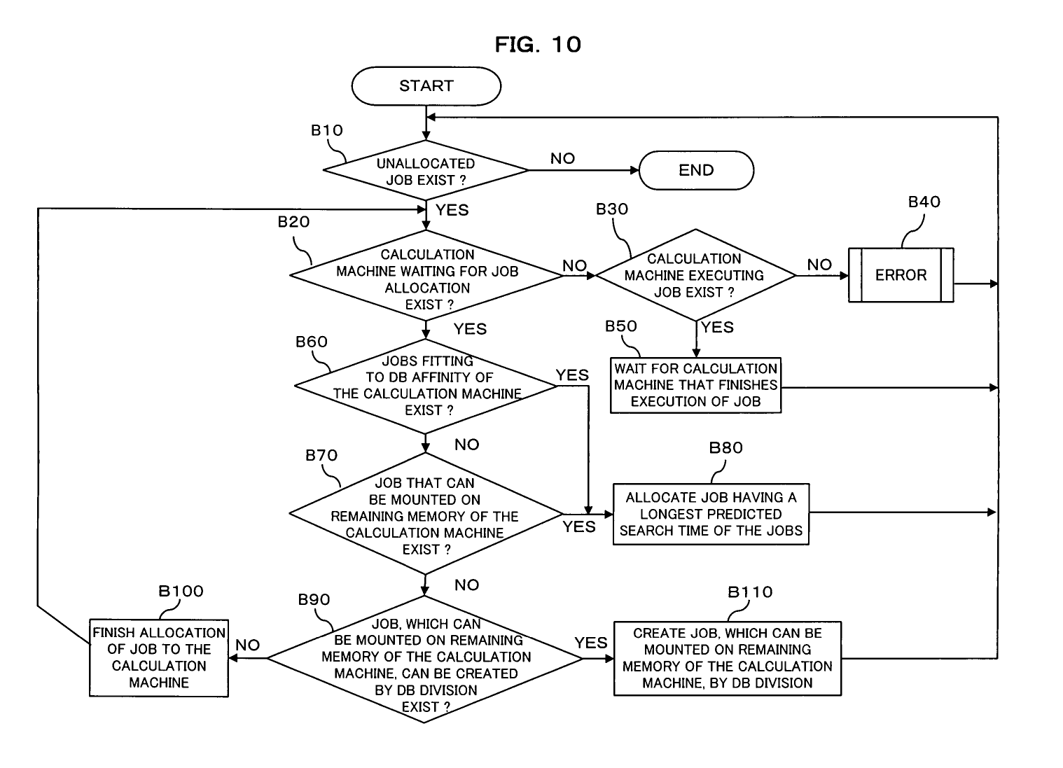

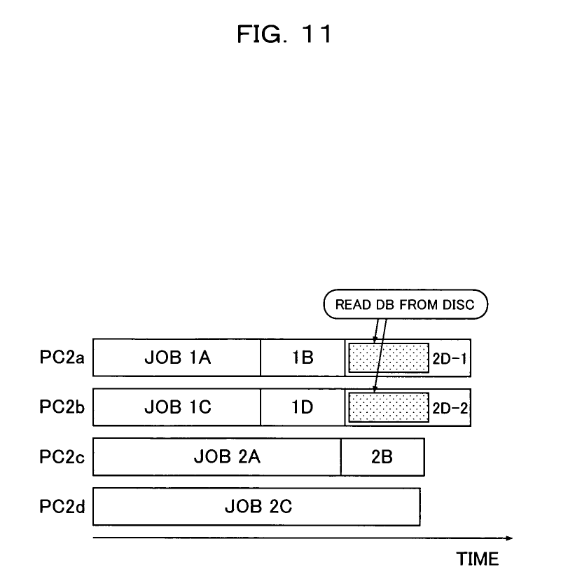

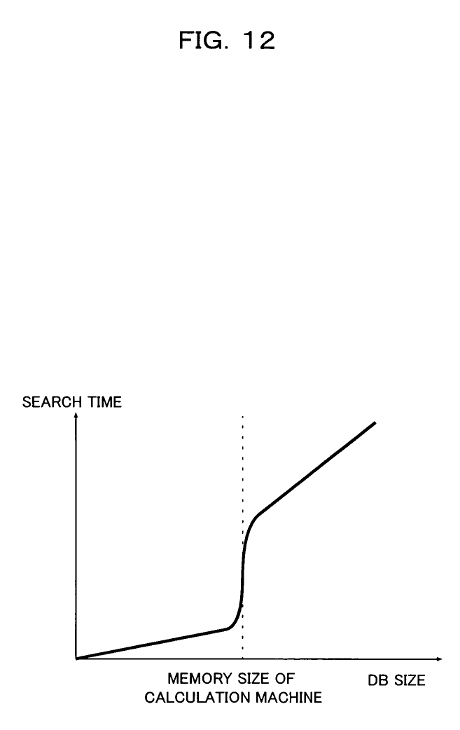

Another job allocation method executed by the allocation management unit 8 in the information search system 1 as the embodiment of the present invention will be explained according to a flowchart (steps B10-B11) shown in FIG. 10 with reference to FIG. 11. Note that FIG. 11 is a view showing an example of another state in which jobs are allocated to the PCs 2 by the allocation management unit 8 in the information search system 1 as the embodiment of the present invention.

The allocation management unit 8 determines whether or not there is an unallocated job (step B10), and when there is no unallocated job (refer to No route of step B10), the process is finished.

Further, when there is an unallocated job (refer to YES route of step B10), the allocation management unit 8 determines whether or not there is a PC 2 waiting for allocation of a job, that is, whether or not there is a PC 2 capable of processing a job (step B20).

When there is no PC 2 waiting for the allocation of a job (refer to NO route of step B20), the allocation management unit 8 determines whether or not there is a PC 2 executing a job (step B30). When there is a PC 2 executing a job (refer to YES route of step B30), the allocation management unit 8 waits for the job of the PC 2 to be finished (step B50), and the process returns to step B10. Further, when there is no PC 2 executing a job (refer to NO route of step B30), the allocation management unit 8 issues a message indicating an error to the operator and the like in the information search system 1 (step B40), and the process returns to step B10.

When there is a PC 2 waiting for the allocation of a job (refer to YES route of step B20), the allocation management unit 8 determines whether or not there is a job whose DB affinity is fitted to (agrees with) the PC 2 with reference to the DB affinity setting unit 9 (step B60). When there is a job whose DB affinity is fitted to the PC 2 (refer to YES route of step B60), the job having the longest predicted search time of the jobs fitted to the PC 2 is allocated to the PC 2 (step B80) with reference to the search times predicted by the processing time prediction unit 11, and the process goes to step B10.

Further, when there is no job whose DB affinity is fitted to the PC 2 (refer to NO route of step B60), the allocation management unit 8 confirms the remaining capacity of the RAM 31 of the PC 2 with reference to the memory management unit 10 and determines whether or not there is a job whose data size is equal to or less than the remaining capacity of the PC 2, that is, whether or not there is a job whose sub database has a size equal to or less than the remaining capacity of the PC 2 (step B70).

When there is a job whose data size is equal to or less than the remaining capacity of the PC 2 (refer to YES route of step B70), the allocation management unit 8 goes to step B80. That is, even if the DB affinity is not fitted, the allocation management unit 8 allocates the job having the longest predicted search time of the jobs whose data sizes are equal to or less than the remaining capacity of the RAM 31 of the PC 2 (step B80), and the process goes to step B10.

Further, when there is no job in which the size of the sub database is equal to or less than the remaining capacity of the RAM 31 of the PC 2 (refer to NO route of step B70), the allocation management unit 8 determines whether or not there is a job which can be created such that the size thereof is set equal to or less than the remaining capacity of the RAM 31 of the PC 2 in the jobs which are not allocated to the PC 2, that is, whether or not there is a job whose sub database can be further divided (step B90).

When there is a job whose sub database can be further divided (refer to YES route of step B90), the allocation management unit 8 causes the sub database creation unit 6 to further divide the sub database of the job to a size equal to or less than the remaining capacity of the RAM 31 of the PC 2 (step B110), and the process goes to step B10.

Further, when there is no job whose sub database can be further divided (refer to NO route of step B90), the allocation of a job to the PC 2 is finished (step B100), and the process goes to step B20.

As shown in FIG. 11, jobs are dynamically allocated to the PCs 2 by the job allocation method described above. Note that it is assumed in the example shown in FIG. 11 that the processing time of the job 2A is 1.5 times the search time predicted by the processing time prediction unit 11 and that the processing time of the job 2C is twice the search time predicted by the processing time prediction unit 11.

Further, in FIG. 11, a job 2D-1 and a job 2D-2 are created by dividing the job 2D again. In the example shown in FIG. 11, since the DB affinities are not fitted to the PCs 2a and 2b in the jobs 2D-1 and 2D-2, a sub database SDB2 as to the jobs 2D-1 and 2D-2 are not cached in the RAMs 31 of the respective PCs 2a, 2b. Accordingly, PCs 2a and 2b must read out the sub database SDB2 as to the jobs 2D-1 and 2D2 from the database 3 and the like (disc access) to process the jobs 2D-1 and 2D-2. However, since the jobs 2D-1 and 2D-2 are created by being divided again by the sub search request creation unit 5 so that a read-out load is reduced, a processing time (search) is reduced in an overall system, which results in that a processing time can be reduced. Further, a risk which occurs when a job whose DB affinity is not fitted is allocated (a sub database read-out load) can be reduced.

Further, since the jobs whose DB affinities are not fitted are allocated in the sizes equal to or less than the remaining capacities of the RAMs 31 of the respective PCs 2a, 2b, the sub database SDB1 is continuously cached in the RAMs 31 of the respective PCs 2a, 2b. Accordingly, when the PCs 2a and 2b are caused to process the sub database SDB1 again, a search speed is not reduced.

Further, an evaluation unit may be provided to evaluate at least one of DB affinities as to the PCs 2, which are set by the DB affinity setting unit 9, sub databases, and predicted search times (predicted amounts of search processing), which are predicted by the processing time prediction unit 11), as to jobs (sub search requests) using an evaluation function as described above. Then, the allocation management unit 8 may allocate the jobs by a random drawing to the PCs 2 based on an evaluation result from the evaluation unit. With the above arrangement, the allocation management unit 8 can easily and securely allocate the jobs to the PCs 2.

Further, the PCs 2 include the RAMs 31 each having the same capacity in the embodiments described above for the sake of convenience. However, the present invention is by no means limited thereto, and the PCs 2 may include RAMs 31 each having a different size, which may be embodied in various modifications within a scope which does not depart from the gist of the present invention.

Further, the management server 20 is realized by a computer (information processing apparatus) having, for example, a server function, and a CPU of the computer executes a information search program so that the computer functions as the sub search request creation unit 5, the sub database creation unit 6, the sub search condition creation unit 7, the allocation management unit 8, the DB affinity setting unit 9, the memory management unit 10, the processing time prediction unit 11, the coupling unit 12, and the evaluation unit which are described above.

Note that the program (information search program) for realizing the functions as the sub search request creation unit 5, the sub database creation unit 6, the sub search condition creation unit 7, the allocation management unit 8, the DB affinity setting unit 9, the memory management unit 10, the processing time prediction unit 11, the coupling unit 12, and the evaluation unit is provided in a form recorded on a recording medium which can be read by a computer, for example, a flexible disc, CD-ROM, CD-R, CD-R/W, DVD, DVD-R, DVD-R/W, magnetic disc, optical disc, magneto-optic disc, and the like. The computer reads the program from the recording medium and uses it by transferring and storing it to and in an internal memory device or an external memory device. Otherwise, the program may be recorded to a memory device (recording medium), for example, a magnetic disc, optical disc, magneto-optic disc, and the like and supplied from the memory device to the computer through a communication path.

When realizing the functions as the sub search request creation unit 5, the sub database creation unit 6, the sub search condition creation unit 7, the allocation management unit 8, the DB affinity setting unit 9, the memory management unit 10, the processing time prediction unit 11, the coupling unit 12, and the evaluation unit, the program stored in an internal memory device (RAM and ROM of a printer in the embodiment) is executed by the micro processor (CPU) of the computer. At this time, the program recorded to the recording medium may be read by the computer and executed thereby.

Note that, in the concept of the computer in the embodiments, the computer includes hardware and an operating system and the hardware is operated under the control of the operating system. Further, when the operating system is not necessary and the hardware is operated by only an application program, the hardware itself corresponds to the computer. The hardware includes at least a micro processor such as a CPU and the like and a means for reading a computer program recorded to a recording medium. In the embodiment, the management server 20 has a function as the computer.

Further, various mediums, which can be read by a computer, such as an IC card, ROM cartridge, magnetic tape, punch card, internal memory device (memory such RAM, ROM, and the like), external memory device, and the like of a computer, and printed matter and the like on which codes such as bar codes and the like are printed can be used as the recording medium of the embodiments, in addition to the flexible disc, CD-ROM, CD-R, CD-R/W, DVD, DVD-R, DVD-R/W, magnetic disc, optical disc, magneto-optic disc, and the like.

Note that when the respective embodiments of the present invention are disclosed, they can be manufactured by persons skilled in the art.

### INDUSTRIAL APPLICABILITY

As described above, the information search system, the information search method, the information search apparatus, the information search program, and the recording medium, to which the program is recorded and which can be read by the computer, of the present invention are useful when a plurality of information processing apparatuses are provided and a search request, which is composed of a database to be searched and a search condition for the database, is processed in parallel by the information processing apparatuses and particularly appropriate to search the database at high speeds by processing the search request at high speeds by the information processing apparatuses.

1. An information search system including a plurality of information processing apparatuses to process a search request, which is composed of a database to be searched and a search condition to the database, in parallel by said plurality of information processing apparatuses, comprising:
a sub database creation unit for creating a plurality of sub databases each having a size equal to or less than the capacity of memory devices provided in the information processing apparatuses based on the search request;
an allocation management unit for allocating the sub databases created by the sub database creation unit to the information processing apparatuses as sub search requests to cause the information processing apparatuses to process the search request to the sub databases;
a DB affinity setting unit capable of setting information as to the sub databases, which are preferentially allocated to the information processing apparatuses by the allocation management unit, as a DB affinity; and
a coupling unit for acquiring results of processing as to the sub search requests issued by said plurality of information processing apparatuses and coupling them,
wherein the allocation management unit allocates the sub search requests to the information processing apparatuses based on the DB affinity.

2. The information search system according to claim 1, comprising:
a sub search condition creation unit for creating sub search conditions by dividing the search condition,
wherein the allocation management unit allocates the sub search conditions to the information processing apparatuses as the sub search request to cause the information processing apparatuses to search the sub databases using the sub search conditions.

3. The information search system according to claim 1, wherein the DB affinity setting unit can previously set sub databases which are preferentially processed.

4. The information search system according to claim 2, wherein the DB affinity setting unit can previously set sub databases which are preferentially processed.

5. The information search system according to claim 1, wherein the DB affinity setting unit sets the DB affinity based on the processing history of the sub search requests in the information processing apparatuses.

6. The information search system according to claim 2, wherein the DB affinity setting unit sets the DB affinity based on the processing history of the sub search requests in the information processing apparatuses.

7. The information search system according to claim 1, comprising:
an empty capacity management unit for managing empty capacities of memory devices provided in the information processing apparatuses,
wherein the allocation management unit allocates the sub databases whose sizes are equal to or less than the empty capacities of the memory devices in the information processing apparatuses to the information processing apparatuses based on the empty capacities managed by the empty capacity management unit.

8. The information search system according to claim 2, comprising:
an empty capacity management unit for managing empty capacities of memory devices provided in the information processing apparatuses,
wherein the allocation management unit allocates the sub databases whose sizes are equal to or less than the empty capacities of the memory devices in the information processing apparatuses to the information processing apparatuses based on the empty capacities managed by the empty capacity management unit.

9. The information search system according to claim 3, comprising:
an empty capacity management unit for managing empty capacities of memory devices provided in the information processing apparatuses,
wherein the allocation management unit allocates the sub databases whose sizes are equal to or less than the empty capacities of the memory devices in the information processing apparatuses to the information processing apparatuses based on the empty capacities managed by the empty capacity management unit.

10. The information search system according to claim 4, comprising:
an empty capacity management unit for managing empty capacities of memory devices provided in the information processing apparatuses,
wherein the allocation management unit allocates the sub databases whose sizes are equal to or less than the empty capacities of the memory devices in the information processing apparatuses to the information processing apparatuses based on the empty capacities managed by the empty capacity management unit.

11. The information search system according to claim 5, comprising:
an empty capacity management unit for managing empty capacities of memory devices provided in the information processing apparatuses,
wherein the allocation management unit allocates the sub databases whose sizes are equal to or less than the empty capacities of the memory devices in the information processing apparatuses to the information processing apparatuses based on the empty capacities managed by the empty capacity management unit.

12. The information search system according to claim 6, comprising:
an empty capacity management unit for managing empty capacities of memory devices provided in the information processing apparatuses,
wherein the allocation management unit allocates the sub databases whose sizes are equal to or less than the empty capacities of the memory devices in the information processing apparatuses to the information processing apparatuses based on the empty capacities managed by the empty capacity management unit.

13. The information search system according to claim 1, comprising:
a processing time prediction unit capable of predicting times required for processing as to the sub search requests executed by the information processing apparatuses,
wherein the allocation management unit preferentially allocates the sub search requests to the information processing apparatuses from the sub search request having a longer time required for said processing based on the times predicted by the processing time prediction unit.

14. The information search system according to claim 13, wherein the sub database creation unit or the sub search condition creation unit divides the sub search requests which are not yet allocated to the information processing apparatuses by the allocation management unit and creates a plurality of sub search requests.

15. The information search system according to claim 1, comprising:
an evaluation unit for evaluating at least one of a DB affinity as to the information processing apparatuses set by the DB affinity setting unit, the sub databases, and times as to the processing predicted by the processing time prediction unit using an evaluation function,
wherein the allocation management unit allocates the sub search requests by a random drawing to the information processing apparatuses based on an evaluation result from the evaluation unit.

16. An information search method of processing a search request, which is composed of a database to be searched and a search condition to the database, in parallel by a plurality of information processing apparatuses, comprising:
a sub search request creation step of creating a plurality of sub search requests each having a size equal to or less than the capacity of memory devices provided in the information processing apparatuses based on the search request;
an allocation management step of allocating the sub search requests created at the sub search request creation step to the information processing apparatuses to cause the information processing apparatuses to process the sub search requests;
a DB affinity setting step of setting information as to the sub databases, which are preferentially allocated to the information processing apparatuses at the allocation management step, as a DB affinity; and
a coupling step of acquiring results of processing as to the sub search requests issued by said plurality of information processing apparatuses and coupling them,
wherein at the allocation management step allocates the sub search requests to the information processing apparatuses based on the DB affinity.

17. An information search apparatus for causing a plurality of information processing apparatuses to process a search request in parallel, which is composed of a database to be searched and a search condition to the database, comprising:
a sub search request creation unit for creating a plurality of sub search requests each having a size equal to or less than the capacity of memory devices provided in the information processing apparatuses based on the search request;
an allocation management unit for allocating the sub search requests created by the sub search request creation unit to the information processing apparatuses to cause the information processing apparatuses to process the sub search requests;
a DB affinity setting unit capable of setting information as to the sub databases, which are preferentially allocated to the information processing apparatuses by the allocation management unit, as a DB affinity; and
a coupling unit for acquiring results of processing as to the sub search requests issued by said plurality of information processing apparatuses and coupling them,
wherein the allocation management unit allocates the sub search requests to the information processing apparatuses based on the DB affinity.

18. A computer-readable recording medium to which an information search program is recorded to cause a computer to execute an information search function for causing a plurality of information processing apparatuses to process a search request in parallel, which is composed of a database to be searched and a search condition to the database, wherein the information search program causes the computer to function as:
a sub search request creation unit for creating a plurality of sub search requests each having a size equal to or less than the capacity of memory devices provided in the information processing apparatuses based on the search request;
an allocation management unit for allocating the sub search requests created by the sub search request creation unit to the information processing apparatuses to cause the information processing apparatuses to process the sub search requests;
a DB affinity setting unit capable of setting information as to the sub databases, which are preferentially allocated to the information processing apparatuses by the allocation management unit, as a DB affinity; and
a coupling unit for acquiring results of processing as to the sub search requests issued by said plurality of information processing apparatuses and coupling them,
wherein the allocation management unit allocates the sub search requests to the information processing apparatuses based on the DB affinity.
